(19) United States
(12) Patent Application Publication
(10) Pub. No.: US 2023/0012821 A1
(43) Pub. Date: Jan. 19, 2023

(54) ELECTRIC MOTOR PROVIDED WITH A COOLING CIRCUIT

(71) Applicant: NOVARES FRANCE, CLAMART (FR)

(72) Inventor: Cédric LEDIEU, Mont Saint Eloi (FR)

(21) Appl. No.: 17/905,211

(22) PCT Filed: Feb. 18, 2021
(86) PCT No.: PCT/FR2021/050291

§ 371 Date: Aug. 29, 2022

(30) Foreign Application Priority Data
Mar. 4, 2020 (FR) FR2002192

(51) Int. Cl. H02K 9/19; H02K 5/173; H02K 5/20; H02K 7/08

(52) U.S. Cl. CPC H02K 9/19; H02K 5/1732; H02K 5/203; H02K 7/083

(57) ABSTRACT

An electric motor includes a rotor mounted on a shaft, a stator arranged around the rotor, and front and rear bearings connected to each other by an attachment component. The front and rear bearings form an internal cavity housing the rotor and the stator, characterized in that the electric motor further includes a bell-shaped thermal insulation cover completely covering the rear bearing and a portion of the front bearing, extending axially from an end face of the front bearing, the thermal insulation cover forming, with the front bearing, at least one inner fluid circulation channel inside which a coolant flows.

### TECHNICAL FIELD

The disclosure relates to an electric motor arranged to allow better removal of the heat generated during its operation.

### BACKGROUND

In general, the current electric motors include a rotor secured to a shaft and a stator which surrounds the rotor. The stator is mounted in a casing which includes bearings for the rotational mounting of the shaft. The rotor includes a body formed by a bundle of laminations or polar wheels (claw pole) held in the form of a stack by means of a suitable fastening system. The body of the rotor includes internal cavities housing permanent magnets. The stator includes a body consisting of a bundle of laminations forming a crown, the inner face of which is provided with teeth delimiting two by two a plurality of slots open towards the inside of the stator body and intended to receive phase windings. These phase windings pass through the slots of the stator body and form winding heads projecting on either side of the stator body. The phase windings may for example consist of a plurality of U-shaped conductor segments, the free ends of two adjacent segments being connected together by welding.

In the rotor, the stack of laminations is axially clamped between a front flange and a rear flange which are coaxially mounted with the shaft. Each flange generally has the shape of a disc extending in a radial plane perpendicular to the axis of the shaft. Each flange includes a central orifice for the coaxial mounting on the shaft and several through holes intended to receive fastening screws passing axially through the entire stack of laminations, said screws being secured to the flanges by means of nuts. The front and rear flanges are generally formed of a non-magnetic, heat-conducting material, for example a metal.

The casing generally includes front and rear bearings assembled together. The bearings define an internal cavity in which the rotor and the stator are housed. Each of the bearings centrally carries a ball bearing for the rotational mounting of the shaft of the rotor.

During the operation of the motor, the current flowing through the phase windings of the stator generates significant heat that must be removed. To cool the stator, there are currently several solutions. One of these solutions is to circulate oil through the shaft of the rotor and then to circulate this oil along the stator body so that it is in contact with the winding heads of the phase windings. Such a solution, however, requires the provision of numerous modifications in the structure of the motor, which makes it difficult to implement, and, therefore, relatively expensive. Another existing solution consists in providing a cooling circuit inside the bearing with which the stator is crimped, a coolant circulating inside the cooling circuit making it possible to remove the heat generated by the stator via the bearing. However, this solution has the disadvantage of being relatively expensive and complex to implement due to the use of specific bearings incorporating an internal cooling circuit.

### SUMMARY

The disclosure therefore aims to provide an electric motor arranged to allow better removal of heat generated during its operation and does not have the disadvantages of the existing solutions described above.

To this end, the disclosure relates to an electric motor comprising a rotor mounted on a shaft, a stator disposed about the rotor, a front bearing and a rear bearing connected together by fastening means, said front and rear bearings forming an internal cavity in which the rotor and the stator are housed, characterized in that the electric motor further comprises a bell-shaped thermal insulation cover completely covering the rear bearing and a part of the front bearing axially extending from an end face of said front bearing, the thermal insulation cover forming with the front bearing at least one liquid circulation internal channel inside which a coolant circulates.

Thus configured, the motor of the disclosure can be cooled more efficiently due to the circulation of a coolant around a part of the front bearing which is in direct contact with the heat-generating elements of the electric motor. Furthermore, the thermal insulation cover having a low thermal conductivity, the coolant will only extract the heat derived from the front bearing and not that coming from the outside. A better energy efficiency of the cooling circuit can thus be obtained.

According to other features, the motor of the disclosure includes one or several of the following optional features considered alone or in combination:
the coolant is selected from water, glycol and an oil.
the thermal insulation cover is made of a plastic material with low thermal conductivity.
the constituent material of the thermal insulation cover is selected from a silicone material, an inorganic polyurethane, a polyurethane-based foam and a polyamide-based foam.
the sound insulation cover is in the form of a structure formed of three layers, namely two external layers of plastic material and an internal layer of foam.
the thermal insulation cover is separated from the part of the axially extending front bearing by sealing elements.
the sealing elements consist of annular seals housed at least partially inside annular grooves formed at the periphery of the part of the axially extending front bearing.
the liquid circulation internal channel has a substantially cylindrical shape, the axis of which is parallel to the axis defined by the shaft of the rotor.
the thermal insulation cover is equipped with at least one liquid inlet pipe and at least one liquid outlet pipe, said inlet and outlet pipes fluidly communicating with the liquid circulation internal channel.
the front and rear bearings are made of metal.
the front bearing is made of aluminum.
the rear bearing is made of steel.
the fastening means are screws.

### BRIEF DESCRIPTION OF THE DRAWINGS

The disclosure will be better understood upon reading the non-limiting following description, made with reference to the appended figures.

FIG. 1 is an exploded perspective view of an electric motor according to a particular embodiment of the disclosure, and

FIG. 2 is a longitudinal sectional view of the motor of FIG. 1.

### DETAILED DESCRIPTION OF THE DRAWINGS

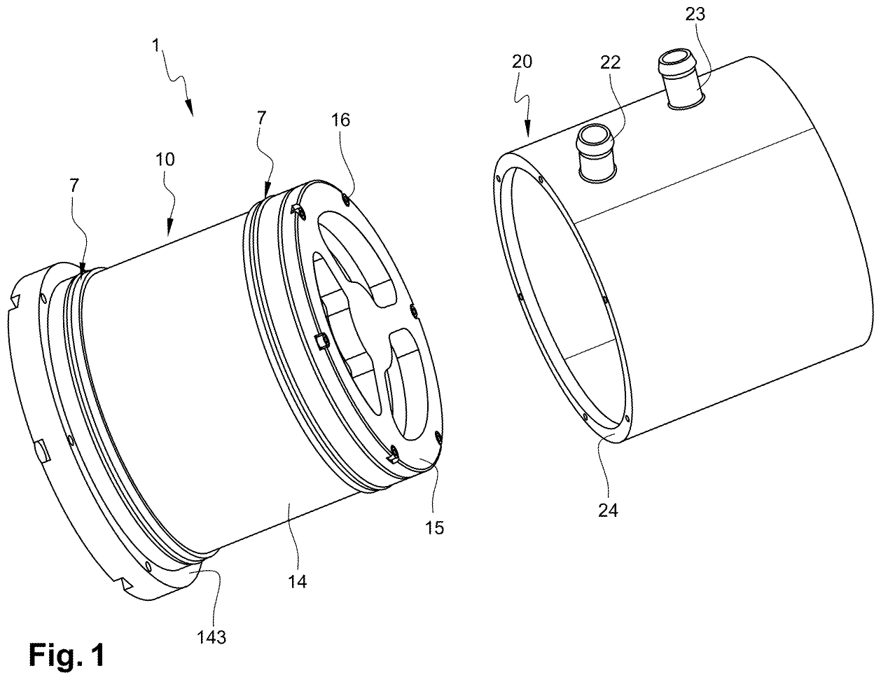

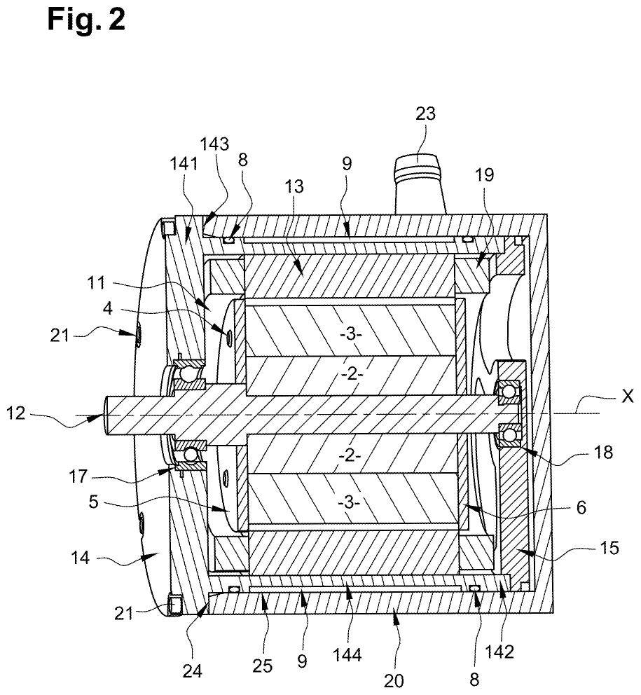

FIGS. 1 and 2 represent an electric motor 1 according to the disclosure comprising two parts, respectively a first part 10 and a second part 20, connected together, in particular by means of screws 21, the second part 20 housing and almost completely covering the first part 10.

The first part 10 comprises a casing in which are housed a rotor 11 secured in rotation to a shaft 12 and an annular stator 13 which surrounds the rotor 11 coaxially to the shaft 12. The casing comprises in particular a front bearing 14 and a rear bearing 15 connected to each other by means of screws 16. The bearings 14, 15 have a hollow shape and each bearing centrally carry a ball bearing 17 and 18 respectively for the rotational mounting of the shaft 12. Winding heads 19 project axially on either side from the stator body 13 and are housed in the intermediate space separating the stator 13 from the respective bearings 14, 15. The front and rear bearings 14, 15 will advantageously be made of metal. In an advantageous configuration of the disclosure, the front bearing 14 will be made of aluminum, while the rear bearing 15 will be made of steel.

In the shown embodiment, the rotor 11 comprises a body formed by a stack of laminations 2 made of a ferromagnetic material, in particular of steel, as well as a plurality of permanent magnets 3 intended to be housed in a plurality of internal cavities formed inside the stack of laminations 2, each internal cavity housing a permanent magnet 3. The stack of laminations 2 is coaxially mounted on the shaft 12 rotatably mounted about an axis X. The shaft 12 may be fitted by force inside a central opening of the stack of laminations 2 so as to bind in rotation the body of the rotor with the shaft 12.

The stack of laminations 2 is formed by an axial pile of laminations which extend in a radial plane perpendicular to the axis X of the shaft 12. A plurality of fastening holes (not shown) are made in the stack of laminations 2 to allow the passage of bolts 4 for fastening the laminations of the stack. These fastening holes are through holes so that it is possible to push a bolt 4 inside each hole. A first end of the bolts 4 bears against the external face of a front end flange 5, while the other end of the bolts bears against the external face of a rear end flange 6. Thus, the stack of laminations 2 is axially clamped between the front end flange 5 and the rear end flange 6. These flanges 5, 6 make it possible to ensure a balancing of the rotor 11 while allowing a good maintenance of the magnets 3 inside their respective cavity. The balancing can be carried out by adding or removing material. The removal of material may be carried out by machining, while the addition of material can be carried out by implanting elements in openings provided for this purpose and distributed along the circumference of the flanges 5, 6.

The second part 20 of the motor 1 consists of a bell-shaped cover which, in the mounted position of the motor represented in FIG. 2, totally covers the rear bearing 15 and a cylindrical part 142 of the front bearing 14 which axially extends from an end face 141 of said front bearing 14, said face 141 having the shape of a disc aligned in a plane perpendicular to the axis X of the shaft 12. The cover 20 rests at an end edge 24 on a shoulder 143 defined by the end face 141.

The cover 20 has a shape substantially complementary to that of the cylindrical part 142 of the front bearing 14 so that, in the mounted position of the motor, this part 142 is in sealed contact with the internal wall 25 of the cover 20, the seal being ensured by two ring-shaped seals 8 which are housed inside two annular grooves 7 formed at the periphery of the part 142. The grooves 7 are disposed on either side of an annular zone 144 of lesser thickness of the part 142. The annular zone 144 forms with the internal wall 25 of the cover 20 a liquid circulation internal channel 9, said channel 9 having a substantially cylindrical shape whose axis is parallel to the axis X defined by the shaft 12 of the rotor 11. The channel 9 thus allows the circulation of a coolant, such as for example water, glycol or an oil, around the cylindrical part 142 of the bearing 14. Thus, during the operation of the motor 1, the heat given off by the stator 13 and transmitted to the front bearing 14 can be directly transferred to the coolant circulating in the internal channel 9. Faster cooling of the stator 13 can thus be obtained. The transfer of heat to the coolant is further improved in the case where the front bearing 14 is made of a material having a high thermal conductivity, such as aluminum for example, and the cover 20 is made of a material with low thermal conductivity, such as a plastic material for example. The coolant supply will take place through a liquid inlet pipe 22 formed at the periphery of the cover 20, said inlet pipe 22 opening into the internal channel 9. The coolant will exit through a liquid outlet pipe 23 formed at the periphery of the cover 20, said outlet pipe 23 also opening into the internal channel 9.

The cover 20 may also have the additional property of attenuating the noise generated by the motor 1. To this end, it will advantageously be made of a plastic material having increased acoustic absorption capacities. In particular, the cover 20 may advantageously be formed from a silicone material, a inorganic polyurethane-based polymer material, a polyurethane-based foam, a polyamide-based foam. It may also have a complex structure formed by three layers, namely two external layers of plastic material and an internal layer of foam. Thus configured, the cover 20 will absorb noise, both mechanical and magnetic, generated by the motor 1 during its operation.

The disclosure is obviously not limited to the configuration of the invention as described above.

1. An electric motor comprising: a rotor mounted on a shaft, a stator disposed about the rotor, a front bearing and a rear bearing connected together by fastening means, said front and rear bearings, forming an internal cavity in which the rotor and the stator are housed, wherein the electric motor comprises a bell-shaped thermal insulation cover completely covering the rear bearing and a part of the front bearing axially extending from an end face of said bearing front, the thermal insulation cover forming with the front bearing at least one liquid circulation internal channel inside which a coolant circulates.

2. The motor according to claim 1, wherein the coolant is selected from a group consisting of: water, glycol, and an oil.

3. The motor according to claim 1, wherein the thermal insulation cover includes a plastic material with low thermal conductivity.

4. The motor according to claim 1, wherein the material constituting the thermal insulation cover is selected from a group consisting of: a silicone material, an inorganic polyurethane, a polyurethane-based foam, and a polyamide-based foam.

5. The motor according to claim 1, wherein the sound insulation cover is in the form of a structure formed of three layers, including two external layers of plastic material and an internal layer of foam.

6. The motor according to claim 1, wherein the thermal insulation cover is separated from the part of the axially extending front bearing by sealing elements.

7. The motor according to claim 6, wherein the sealing elements include annular seals housed at least partially inside annular grooves formed at the periphery of the part of the axially extending front bearing.

8. The motor according to claim 1, wherein the liquid circulation internal channel has a substantially cylindrical shape whose axis is parallel to the axis defined by the shaft of the rotor.

9. The motor according to claim 1, wherein the thermal insulation cover is equipped with at least one liquid inlet pipe and at least one liquid outlet pipe, said inlet and outlet pipes fluidly communicating with the liquid circulation internal channel.

10. The motor according to claim 1, wherein the front and rear bearings are made of metal.

11. The motor according to claim 10, wherein the front bearing is made of aluminum.

12. The motor according to claim 10, wherein the rear bearing is made of steel.

13. The motor according to claim 1, wherein the fastening means are screws.
